(19) United States
(12) Patent Application Publication
(10) Pub. No.: US 2016/0263660 A1
(43) Pub. Date: Sep. 15, 2016

(54) Multipurpose Cutting Assembly

(71) Applicant: Jose Lopez, Palmdale, CA (US)

(72) Inventor: Jose Lopez, Palmdale, CA (US)

(21) Appl. No.: 14/641,610

(22) Filed: Mar. 9, 2015

(51) Int. Cl. B23B 29/20; B23Q 3/155

(52) U.S. Cl. CPC B23B 29/20; B23Q 3/155; B23Q 2003/15586

(57) ABSTRACT

A multipurpose cutting assembly for facilitating quick change of cutting fixtures on a turret of a computer numerical control assembly includes a mount that is removably coupled to the turret. A plurality of fittings is provided and a selected one of the fittings is removably coupled to the mount. Each of the fittings may perform routing on the computer numerical control assembly.

### BACKGROUND OF THE DISCLOSURE

### Field of the Disclosure

The disclosure relates to cutting devices and more particularly pertains to a new cutting device for facilitating quick change of cutting fixtures on a computer numerical control turret

### SUMMARY OF THE DISCLOSURE

An embodiment of the disclosure meets the needs presented above by generally comprising a mount that is removably coupled to a turret of a computer numerical control assembly. A plurality of fittings is provided and a selected one of the fittings is removably coupled to the mount. Each of the fittings performs routing on the computer numerical control assembly

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a multipurpose cutting assembly according to an embodiment of the disclosure.

FIG. 2 is a top view of an embodiment of the disclosure.

FIG. 3 is a right side view of an embodiment of the disclosure.

FIG. 4 is a cross sectional view taken along line 4-4 of FIG. 2 of an embodiment of the disclosure.

FIG. 5 is a left side view of an embodiment of the disclosure.

FIG. 6 is a perspective view of an embodiment of the disclosure.

FIG. 7 is a perspective in-use view of an embodiment of the disclosure.

### DESCRIPTION OF THE PREFERRED EMBODIMENT

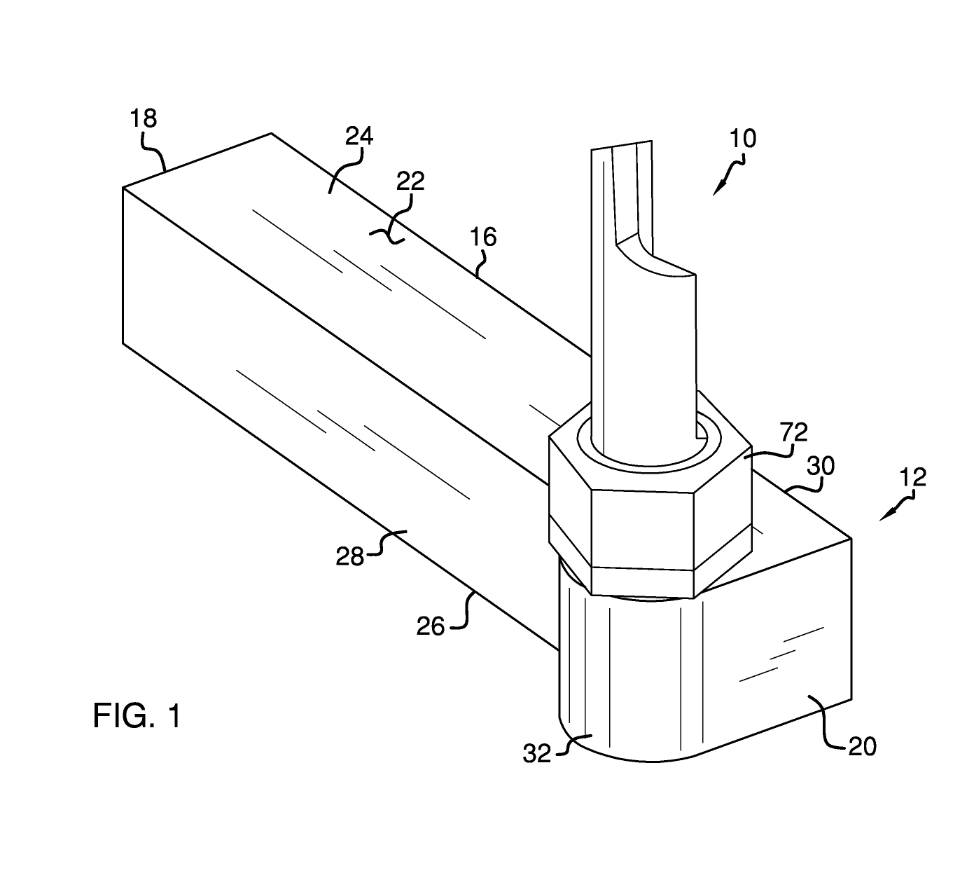

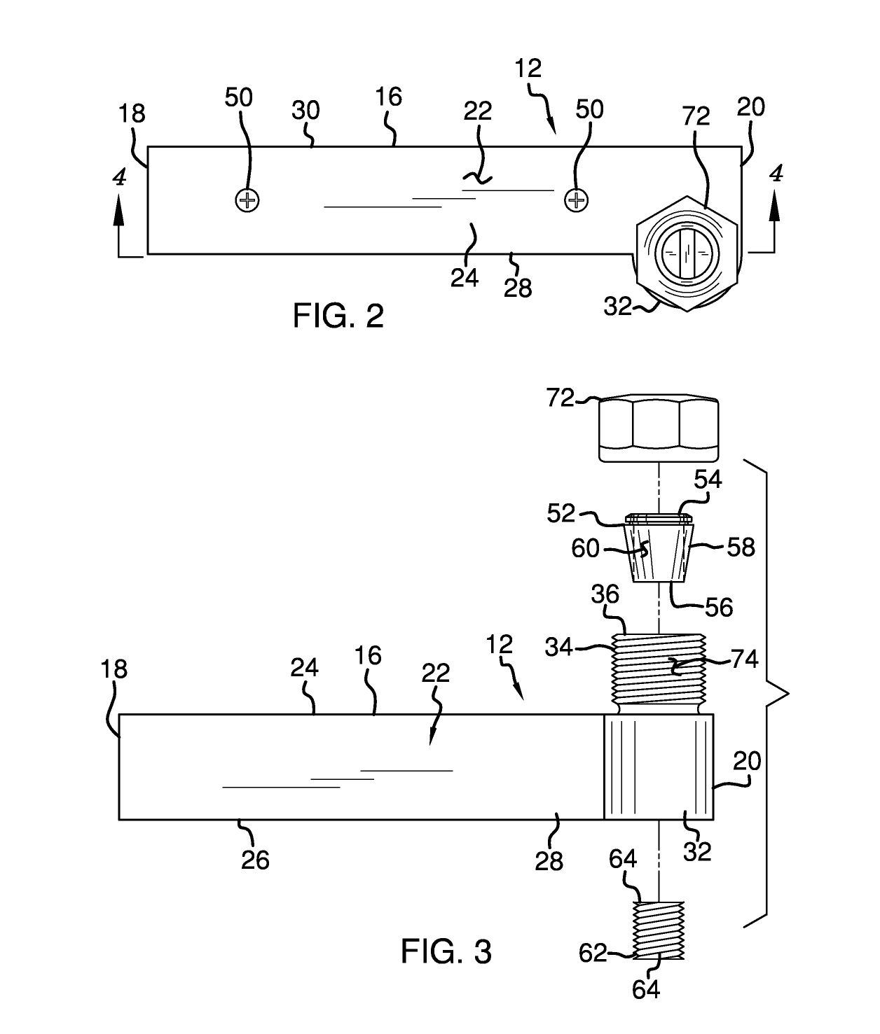

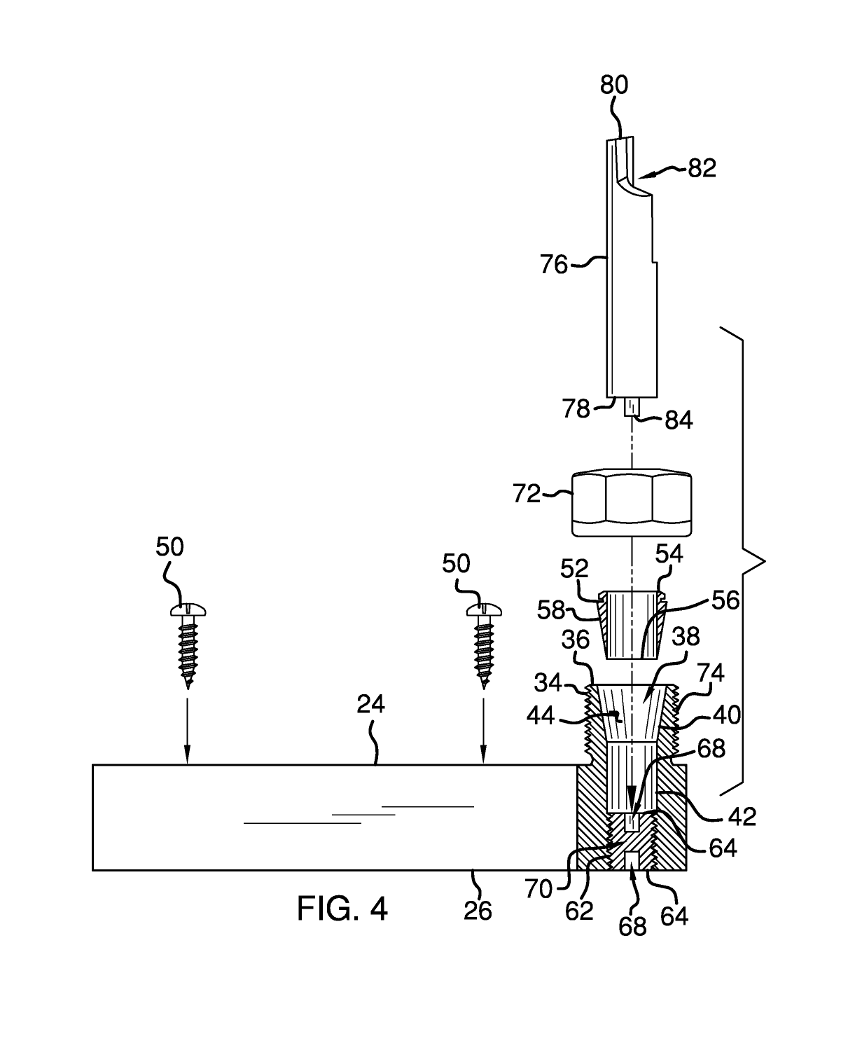

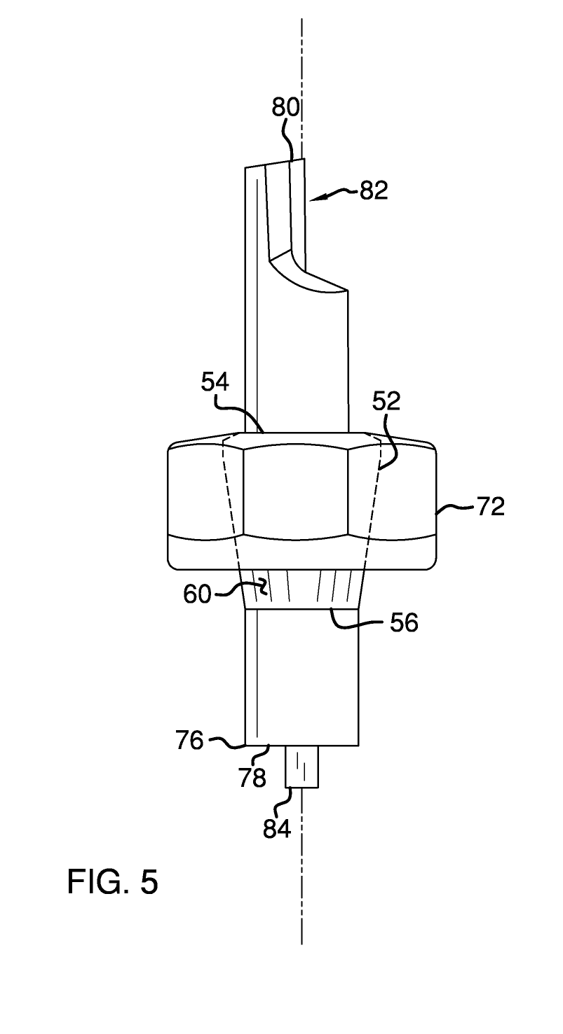

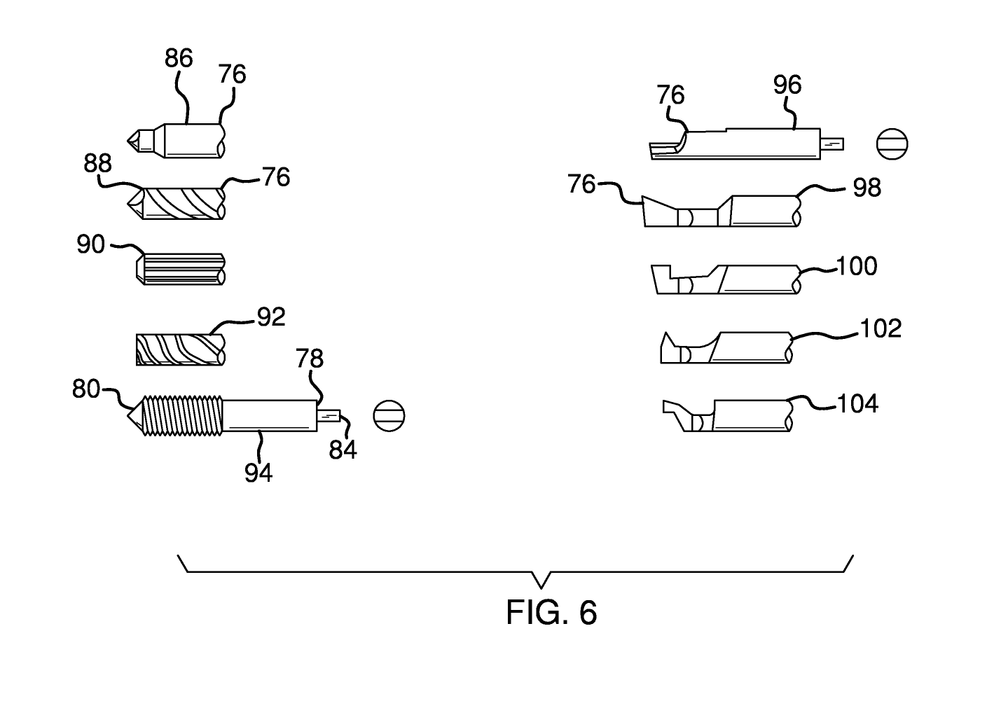

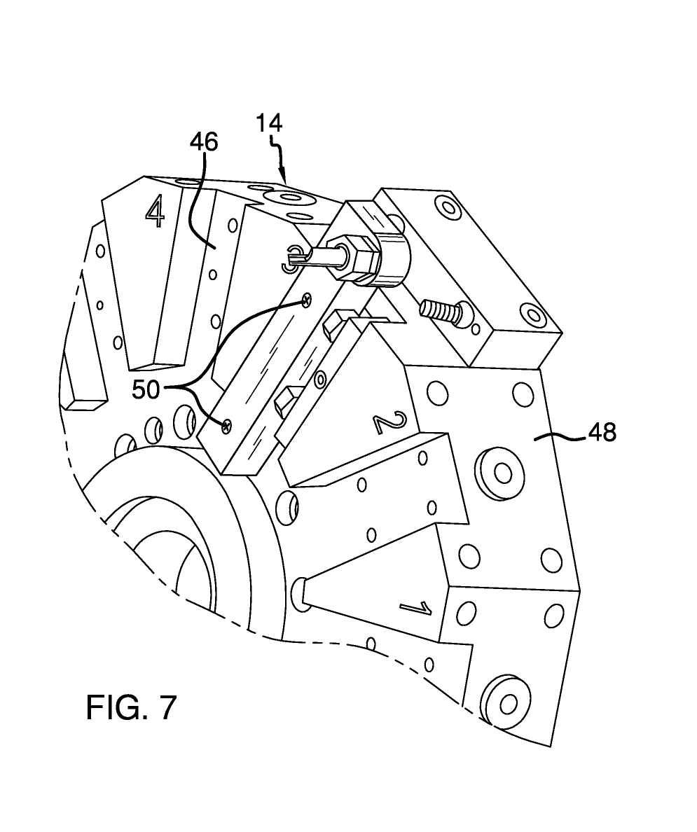

With reference now to the drawings, and in particular to FIGS. 1 through 7 thereof, a new cutting device embodying the principles and concepts of an embodiment of the disclosure and generally designated by the reference numeral 10 will be described.

As best illustrated in FIGS. 1 through 7, the multipurpose cutting assembly 10 generally comprises a mount 12 that may be removably coupled to a turret of a computer numerical control assembly 14. The turret of a computer numerical control assembly 14 may be of any conventional design. The mount 12 comprises a holder 16 that has a first end 18, a second end 20 and a peripheral surface 22 extending between the first end 18 and the second end 20. The peripheral surface 22 has an upper side 24, a lower side 26, a first lateral side 28 and a second lateral side 30. The holder 16 is elongated between the first end 18 and the second end 20 and the first lateral side 28 has a lobed portion 32. The lobed portion 32 is positioned adjacent to the second end 20 and the upper 24 and lower 26 sides extend onto the lobed portion.

The upper side 24 has a receiver 34 coupled to and extending upwardly therefrom and the receiver 34 is substantially positioned on the lobed portion 32. The receiver 34 has a distal end 36 with respect to the upper side 24 and the holder 16 has an aperture 38 extending through the distal end 36 of the receiver 34 and the lower side 26. The aperture 38 has a first section 40 and a second section 42 and the first section 40 extends between the distal end 36 and a point that is closer to the upper side 24 than the distal end 36. The aperture 38 has a bounding surface 44 and the bounding surface 44 corresponding to the first section 40 tapers inwardly between the distal end 36 and the second section 42. The second section 42 extends between the first section 40 and the lower side 26. The bounding surface 44 corresponding to the second section 42 is threaded between the lower side 26 and a point that is closer to the lower side 26 than the first section 40.

The holder 16 may be removably fastened to an exposed side 46 of the turret of a computer numerical control assembly 14. The holder 16 is positioned to have the lower side 26 abut the exposed side 46 of the turret of a computer numerical control assembly 14 such that the receiver 34 is positioned adjacent to an outer edge 48 of the turret of a computer numerical control assembly 14. At least one fastener 50 extends through the holder 16 and engages the exposed side 46 to retain the holder 16 on the exposed side 46. The fastener 50 may be a bolt or the like and the holder 16 may comprise an ER 16 holder or the like.

A collet 52 is provided that has top end 54, a bottom end 56 and a peripheral wall 58 extending therebetween. The top end 54 and the bottom end 56 are open and the collet 52 is substantially hollow. The peripheral wall 58 has an outer surface 60 and the outer surface 60 of the peripheral wall 58 tapers inwardly between the top end 54 and the bottom end 56. The collet 52 is removably positioned within the first section 40 of the aperture 38 such that the outer surface 60 abuts the bounding surface 44. The bounding surface 44 of the first section 40 restricts the collet 52 from moving into the second section 42. The collet 52 may comprise an ER 16 collet manufactured by Royal Products, 200 Oser Avenue, Hauppague, N.Y., 11788 or the like.

A plug 62 is provided that has a pair of ends 64 and an outermost surface 66 extending therebetween. Each of the ends 64 has a groove 68 extending inwardly toward a center 70 of the plug 62. The outermost surface 66 threadably engages the bounding surface 44 of the second section 42. A nut 72 threadably engages an exterior surface 74 of the receiver 34 and the nut 72 retains the collet 52 within the receiver 34.

A plurality of fittings 76 is provided and each of the fittings 76 has a primary end 78 and a secondary end 80. Each of the fittings 76 is elongated between the primary end 78 and the secondary end 80 and each of the fittings 76 has a unique cutting section 82 extending from the secondary end 80 toward the primary end 78. Each of the fittings 76 has a tab 84 coupled to and extending away from the primary end 78. The primary end 78 of a selected one of the fittings 76 is directed through the collet 52 after the collet 52 is positioned within the aperture 38 such that the tab 84 engages the groove 68 in the plug 62.

The plug 62 is rotated in the aperture 38 such that the cutting section 82 is positioned at a selected orientation with respect to an axis extending through the distal end 36 of the receiver 34 and the lower side 26 of the holder 16. The nut 72 is tightened on the receiver 34 such that the selected fitting 76 is compressed within the collet 52 thereby retaining the cutting section 82 at the selected orientation. The fittings 76 may comprise a center drill 86, a drill 88, a reamer 90, an end mill 92, a tap 94, a boring bar 96, a grooving bar 98, a threading bar 100, a cutting bar 102 and a trepanning bar 104.

In use, the holder 16 is fastened to the exposed side 46 of the turret of a computer numerical control assembly 14. The collet 52 is inserted into the first section 40 of the aperture 38. The primary end 78 of the selected fitting 76 is inserted into the aperture 38 until the tab 84 engages the groove 68 in the plug 62. The nut 72 is slid over the selected fitting 76 to threadably engage the receiver 34. The plug 62 is rotated until the cutting section 82 of the fitting 76 is positioned at the selected orientation. The nut 72 is tightened to retain the fitting 76 at the selected orientation.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multipurpose cutting assembly configured to facilitate a variety of fittings being easily interchangeable on a turret of a computer numerical control assembly, said assembly comprising:
a mount configured to be removably coupled to a turret of a computer numerical control assembly; and
a plurality of fittings, a selected one of said fittings being removably coupled to said mount, each of said fittings being configured to perform routing on the computer numerical control assembly

2. The assembly according to claim 1, wherein said mount comprises a holder having a first end, a second end and a peripheral surface extending between said first end and said second end, said peripheral surface having an upper side, a lower side, a first lateral side and a second lateral side, said holder being elongated between said first end and said second end, said first lateral side having a lobed portion, said lobed portion being positioned adjacent to said second end, said upper side having a receiver coupled to and extending upwardly therefrom, said receiver being substantially positioned on said lobed portion, said receiver having a distal end with respect to said upper side.

3. The assembly according to claim 2, wherein said holder has an aperture extending through said distal end of said receiver and said lower side, said aperture having a first section and a second section, said first section extending between said distal end and a point being closer to said upper side than said distal end.

4. The assembly according to claim 3, wherein said aperture has a bounding surface, said bounding surface corresponding to said first section tapering inwardly between said distal end and said second section, said second section extending between said first section and said lower side, said bounding surface corresponding to said second section being threaded between said lower side and a point being closer to said lower side than said first section, said holder being configured to be removably fastened to an exposed side of the turret having said lower side abutting the exposed side such that said receiver is positioned adjacent to an outer edge of the turret.

5. The assembly according to claim 4, further comprising a collet having a front end, a back end and a peripheral wall extending therebetween, said front end and said back end being open, said collet being substantially hollow, said peripheral wall having an outer surface, said outer surface of said peripheral wall tapering inwardly between said front end and said back end, said collet being removably positioned within said first section of said aperture having said outer surface abutting said bounding surface.

6. The assembly according to claim 5, further comprising a plug having a pair of ends and an outermost surface extending therebetween, each of said ends having a groove extending inwardly toward a center of said plug, said outermost surface threadably engaging said bounding surface of said second section.

7. The assembly according to claim 6, further comprising a nut threadably engaging an exterior surface of said receiver, said nut retaining said collet within said receiver.

8. The assembly according to claim 1, wherein each of said fittings has a primary end and a secondary end, each of said fittings being elongated between said primary end and said secondary end, each of said fittings having a unique cutting section extending from said secondary end toward said primary end, each of said fittings having a tab coupled to and extending away from said primary end.

9. The assembly according to claim 8, further comprising:
said holder having a lower side, said holder having an aperture extending therethrough;
a receiver having a distal end;
a collet;
a plug having a groove;
a nut; and
said primary end of a selected one of said fittings being directed through said collet after said collet is positioned within said aperture such that said tab engages said groove in said plug, said plug being rotated in said aperture such that said cutting section is positioned at a selected orientation with respect to an axis extending through said distal end of said receiver and said lower side of said holder, said nut being tightened on said receiver such that said fitting is compressed within said collet thereby retaining said cutting section at said selected orientation.

10. A multipurpose cutting assembly configured to facilitate a variety of fittings being easily interchangeable on a turret of a computer numerical control assembly, said assembly comprising:
a mount configured to be removably coupled to a turret of a computer numerical control assembly, said mount comprising:
a holder having a first end, a second end and a peripheral surface extending between said first end and said second end, said peripheral surface having an upper side, a lower side, a first lateral side and a second lateral side, said holder being elongated between said first end and said second end, said first lateral side having a lobed portion, said lobed portion being positioned adjacent to said second end, said upper side having a receiver coupled to and extending upwardly therefrom, said receiver being substantially positioned on said lobed portion, said receiver having a distal end with respect to said upper side, said holder having an aperture extending through said distal end of said receiver and said lower side, said aperture having a first section and a second section, said first section extending between said distal end and a point being closer to said upper side than said distal end, said aperture having a bounding surface, said bounding surface corresponding to said first section tapering inwardly between said distal end and said second section, said second section extending between said first section and said lower side, said bounding surface corresponding to said second section being threaded between said lower side and a point being closer to said lower side than said first section, said holder being configured to be removably fastened to an exposed side of the turret having said lower side abutting the exposed side such that said receiver is positioned adjacent to an outer edge of the turret;
a collet having front end, a back end and a peripheral wall extending therebetween, said front end and said back end being open, said collet being substantially hollow, said peripheral wall having an outer surface, said outer surface of said peripheral wall tapering inwardly between said front end and said back end, said collet being removably positioned within said first section of said aperture having said outer surface abutting said bounding surface;
a plug having a pair of ends and an outermost surface extending therebetween, each of said ends having a groove extending inwardly toward a center of said plug, said outermost surface threadably engaging said bounding surface of said second section; and
a nut threadably engaging an exterior surface of said receiver, said nut retaining said collet within said receiver; and
a plurality of fittings, each of said fittings having a primary end and a secondary end, each of said fittings being elongated between said primary end and said secondary end, each of said fittings having a unique cutting section extending from said secondary end toward said primary end, each of said fittings having a tab coupled to and extending away from said primary end, said primary end of a selected one of said fittings being directed through said collet after said collet is positioned within said aperture such that said tab engages said groove in said plug, said plug being rotated in said aperture such that said cutting section is positioned at a selected orientation with respect to an axis extending through said distal end of said receiver and said lower side of said holder, said nut being tightened on said receiver such that said fitting is compressed within said collet thereby retaining said cutting section at said selected orientation.
